(19) United States
(12) Patent Application Publication
(10) Pub. No.: US 2015/0279257 A1
(43) Pub. Date: Oct. 1, 2015

(54) Method and Apparatus for Measuring the Electrical Property of TFT

(71) Applicant: Shenzhen China Star Optoelectronics Technology Co. Ltd., Shenzhen, Guangdong (CN)

(72) Inventor: Yanfeng Fu, Shenzhen (CN)

(73) Assignee: Shenzhen China Star Optoelectronics Technology Co. Ltd., Shenzhen, Guangdong (CN)

(21) Appl. No.: 14/240,459

(22) PCT Filed: Jan. 7, 2014
(86) PCT No.: PCT/CN2014/070198

§ 371 Date: Feb. 24, 2014

(30) Foreign Application Priority Data
Dec. 13, 2013 (CN) 201310680830.9

(51) Int. Cl. G09G 3/00

(52) U.S. Cl. CPC G09G 3/006

(57) ABSTRACT

The present invention discloses a method and an apparatus for measuring the electrical property of TFT. The method for measuring the electrical property of TFT comprises: providing two source-drain test units respectively connected with source drain metals, and a gate test unit connected with a gate metal; applying a first voltage on the gate test unit, applying a second voltage on the two ends of the two source-drain test units, so that a doped amorphous silicon semiconductor contacting with the source-drain test units is turned on; and measuring the current between the two source-drain test units. In the embodiment of the present invention, it can not only quickly and easily obtain the ohmic contact resistance between the source drain metals and the doped amorphous silicon semiconductor, but also understand the changes of the ohmic contact resistance by measuring the current variation, which facilitates to monitor the electrical property of TFT.

This application claims priority to Chinese Patent Application Serial No. 201310680830.9, named as “method and apparatus for measuring the electrical property of TFT”, filed on Dec. 13, 2013, the specification of which is incorporated herein by reference.

### BACKGROUND OF THE INVENTION

1. Field of the Invention

The present invention relates to the technology fields of image display, and in particular to a method and an apparatus for measuring the electrical property of TFT.

2. The Related Arts

In the array design of the present thin film transistor liquid crystal display (TFT-LCD), a test element group (TEG) will be designed at the periphery of the array substrate, which is used to monitor the electrical property of TFT, such as resistance, capacitance, TFT I-V curve, etc. The resistance measurement comprises the resistances of gate metal leads, source drain metal leads, indium tin oxide, and the passivation layer through hole. However, the ohmic contact resistance between the source drain metal and the doped amorphous silicon semiconductor (n+a-Si:H) cannot be measured and monitored due to no corresponding design.

### SUMMARY OF THE INVENTION

The technical issue to be solved by the present invention is to provide a method and an apparatus for measuring the electrical property of TFT, which can measure and monitor the ohmic contact resistance between the source drain metals and the doped amorphous silicon semiconductor.

In order to solve the technical issue, the embodiment according to the present invention provides a method for measuring the electrical property of TFT, comprising:

providing two source-drain test units respectively connected with source drain metals, and a gate test unit connected with a gate metal;
applying a first voltage on the gate test unit, applying a second voltage on the two ends of the two source-drain test units, so that a doped amorphous silicon semiconductor contacting with the source-drain test units is turned on; and
measuring the current between the two source-drain test units.

Wherein, the source-drain test units and the gate test unit are metal foils.

Wherein, the source-drain test units are connected with the source drain metals through a metal test lead, the gate test unit is connected with the gate metal through the metal test lead.

Wherein, the first voltage is a high voltage used to turn on the source and the drain, the second voltage is a predetermined value.

The present invention further provides a method for measuring the electrical property of TFT, comprising:

providing two source-drain test units respectively connected with source drain metals, and a gate test unit connected with a gate metal;
applying a high voltage used to turn on the source and the drain on the gate test unit, applying a voltage with a predetermined value on the two ends of the two source-drain test units, so that a doped amorphous silicon semiconductor contacting with the source-drain test units is turned on; and
measuring the current between the two source-drain test units.

The present invention further provides an apparatus for measuring the electrical property of TFT, comprising:

a gate test unit, which is connected with a gate metal, and can be applied with a first voltage;
two source-drain test units, which are respectively connected with source drain metals, and two ends thereof can be applied with a second voltage;
the first voltage and the second voltage turning on a doped amorphous silicon semiconductor connected with the source drain metals; and
a measure unit, which is used to measure the current between the two source-drain test units.

Wherein, the source-drain test units and the gate test unit are metal foils.

Wherein, the source-drain test units are connected with the source drain metals through a metal test lead, the gate test unit is connected with the gate metal through the metal test lead.

Wherein, the first voltage is a high voltage used to turn on the source and the drain, the second voltage is a predetermined value.

In the embodiment of the present invention, it can not only quickly and easily obtain the ohmic contact resistance between the source drain metals and the doped amorphous silicon semiconductor, but also understand the changes of the ohmic contact resistance by measuring the current variation, which facilitates to monitor the electrical property of TFT.

### BRIEF DESCRIPTION OF THE DRAWINGS

In order to more clearly illustrate the embodiment of the present invention or the technical issue of the prior art, the accompanying drawings and the detailed descriptions are as follows. Obviously, the following description of the accompanying drawings are only some embodiments according to the present invention, for persons of ordinary skill in this field, they can also obtain other drawings based on these drawings without creative effort.

FIG. 1 is a flow chart of a method for measuring the electrical property of TFT according to the first embodiment of the present invention;

FIG. 2 is a principle diagram of a method for measuring the electrical property of TFT according to the first embodiment of the present invention;

FIG. 3 is a schematic view illustrating the structure of an apparatus for measuring the electrical property of TFT according to the second embodiment of the present invention; and

FIG. 4 is a cross-sectional schematic view along A-A′ direction as shown in FIG. 3.

### DETAILED DESCRIPTION OF THE PREFERRED EMBODIMENTS

The detailed descriptions accompanying drawings and the embodiment of the present invention are as follows.

Referring to FIG. 1, the first embodiment of the present invention provides a method for measuring the electrical property of TFT, comprising:

step S1, providing two source-drain test units respectively connected with source drain metals, and a gate test unit connected with a gate metal;
step S2, applying a first voltage on the gate test unit, applying a second voltage on the two ends of the two source-drain test units, so that a doped amorphous silicon semiconductor contacting with the source-drain test units is turned on; and
step S3, measuring the current between the two source-drain test units.

Wherein, the source-drain test units and the gate test unit are metal foils, which are connected to the source drain metals and the gate metal through a test lead (also metal lead).

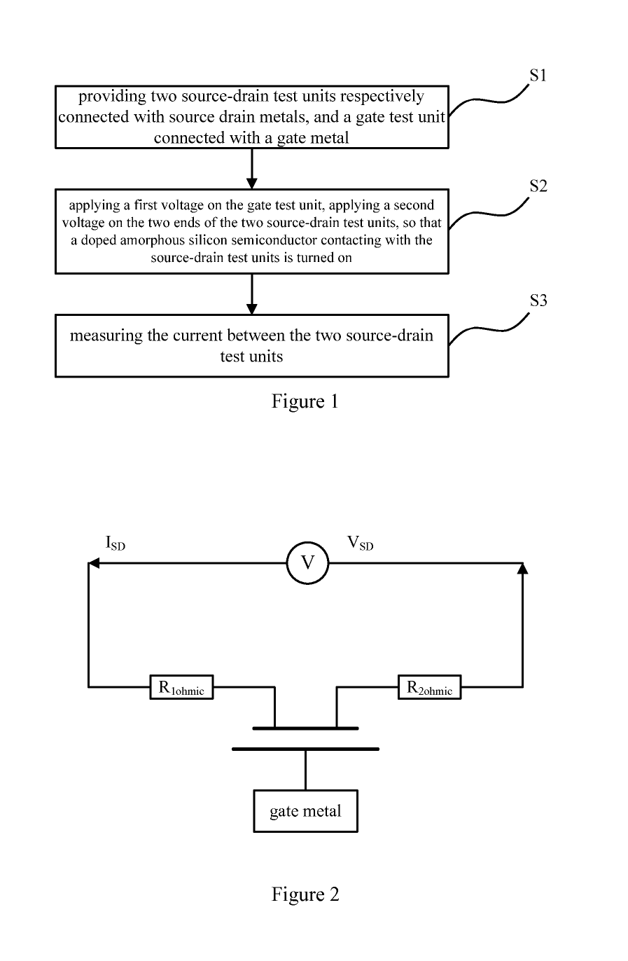

The principle of the method for measuring the electrical property of TFT according to the present embodiment is as follows. Apply the first voltage on the gate test unit. The first voltage is a high voltage higher than the breakover voltage, which can turn on the source and the drain. As for TFT units, the characteristics of the source and the drain are the same, and the functions thereof can be exchanged. At the same time, apply the second voltage on the two ends of the two source-drain test units, so that the doped amorphous silicon semiconductor n+a-Si:H contacting with the source-drain test units is turned on. Because the resistances of the n+a-Si:H, the test leads, and the source drain metals can be negligible comparing to the ohmic contact resistance between the source drain metals and the n+a-Si:H, the ohmic contact resistance between the source drain metals and the n+a-Si:H can be obtained by measuring the voltage and the current between the two ends of the two source-drain test units. The second voltage applied on the two ends of the two source-drain test units is a predetermined value, so it only needs to measure the current between the two ends of the two source-drain test units practically. For details, referring to FIG. 2, assuming the second voltage applied on the two ends of the two source-drain test units is V_{SD} and the current between the two ends of the two source-drain test units is I_{SD}, then the ohmic contact resistance between the source drain metals and the n+a-Si:H is R_{ohmic}=V_{SD}/I_{SD}. Moreover, FIG. 2 shows the equivalent circuit of the embodiment of the present invention. R_{1 ohmic} and R_{2 ohmic} are respectively the ohmic contact resistances between the drain metal and the n+a-Si:H and that between the source metal and the n+a-Si:H. As mentioned above, the characteristics of the source and the drain of TFT units are the same, and the functions thereof can be exchanged. Therefore, R_{1 ohmic} and R_{2 ohmic} are the same, R_{ohmic}=R_{1 ohmic}+R_{2 ohmic}.

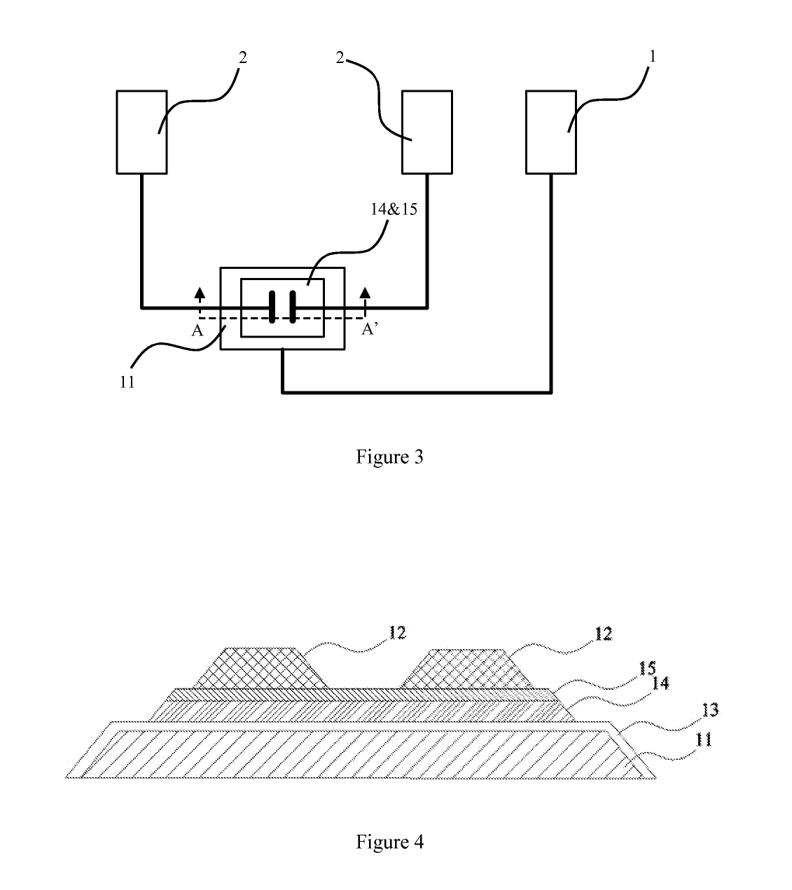

Referring to FIGS. 3 and 4, corresponding to the method for measuring the electrical property of TFT according to the first embodiment of the present invention, the second embodiments of the present invention provides an apparatus for measuring the electrical property of TFT, comprising:
a gate test unit 1, which is connected with a gate metal 11, and can be applied with a first voltage;
   two source-drain test units 2, which are respectively connected with source drain metals 12, and two ends thereof can be applied with a second voltage;
   the first voltage and the second voltage turning on a doped amorphous silicon semiconductor 15 connected with the source drain metals 12; and
   a measure unit, which is used to measure the current between the two source-drain test units 2.

FIG. 4 shows a schematic view illustrating the structure of the TFT device measured by the present embodiment. Wherein, the gate metal 11 is covered with a gate insulating layer (specifically is a silicon nitride layer) 13. On the gate insulating layer 13 are sequentially formed with the amorphous silicon semiconductor layer (a-Si:H) 14 and the doped amorphous silicon semiconductor layer (n+a-Si:H) 15. The source drain metals 12 are provided on the doped amorphous silicon semiconductor layer 15.

The apparatus for measuring the electrical property of TFT according to the present embodiment provides the gate test unit 1 connected with the gate metal 11 through the metal lead; provides the two source-drain test units 2 respectively connected with the source drain metals 12 through the metal leads. Apply the first voltage on the gate test unit 1, wherein the first voltage is a high voltage higher than the breakover voltage, which can turn on the source and the drain. At the same time, apply the second voltage on the two ends of the two source-drain test units 2, so that the doped amorphous silicon semiconductor 15 contacting with the source-drain test units 12 is turned on. Because the resistances of the doped amorphous silicon semiconductor 15, the test leads, and the source drain metals 12 can be negligible comparing to the ohmic contact resistance between the source drain metals 12 and the doped amorphous silicon semiconductor 15, the ohmic contact resistance between the source drain metals 12 and the doped amorphous silicon semiconductor 15 can be obtained by measuring the voltage and the current between the two ends of the two source-drain test units 2. The second voltage applied on the two ends of the two source-drain test units 2 is a predetermined value, so it only needs to measure the current between the two ends of the two source-drain test units 2 practically. Specific measurement and calculation refer to the description of FIG. 2 mentioned above.

The apparatus for measuring the electrical property of TFT according to the present embodiment can be designed the pattern through the mask, which can be achieved by the existing process. Wherein, the source-drain test units 2 and the gate test unit 1 are metal foils, the test leas are metal leads.

In the embodiment of the present invention, it can not only quickly and easily obtain the ohmic contact resistance between the source drain metals and the doped amorphous silicon semiconductor, but also understand the changes of the ohmic contact resistance by measuring the current variation, which facilitates to monitor the electrical property of TFT.

The preferred embodiments according to the present invention are mentioned above, which cannot be used to define the scope of the right of the present invention. Those modifications and variations are considered encompassed in the scope of protection defined by the clams of the present invention.

What is claimed is:

1. A method for measuring the electrical property of TFT, comprising:
providing two source-drain test units respectively connected with source drain metals, and a gate test unit connected with a gate metal;
applying a first voltage on the gate test unit, applying a second voltage on the two ends of the two source-drain test units, so that a doped amorphous silicon semiconductor contacting with the source-drain test units is turned on; and
measuring the current between the two source-drain test units.

2. The method for measuring the electrical property of TFT as claimed in claim 1, wherein the source-drain test units and the gate test unit are metal foils.

3. The method for measuring the electrical property of TFT as claimed in claim 2, wherein the source-drain test units are connected with the source drain metals through a metal test lead, the gate test unit is connected with the gate metal through the metal test lead.

4. The method for measuring the electrical property of TFT as claimed in claim 1, wherein the first voltage is a high voltage used to turn on the source and the drain, the second voltage is a predetermined value.

5. A method for measuring the electrical property of TFT, comprising:
providing two source-drain test units respectively connected with source drain metals, and a gate test unit connected with a gate metal;
applying a high voltage used to turn on the source and the drain on the gate test unit, applying a voltage with a predetermined value on the two ends of the two source-drain test units, so that a doped amorphous silicon semiconductor contacting with the source-drain test units is turned on; and
measuring the current between the two source-drain test units.

6. An apparatus for measuring the electrical property of TFT, comprising:
a gate test unit, which is connected with a gate metal, and can be applied with a first voltage;
two source-drain test units, which are respectively connected with source drain metals, and two ends thereof can be applied with a second voltage;
the first voltage and the second voltage turning on a doped amorphous silicon semiconductor connected with the source drain metals; and
a measure unit, which is used to measure the current between the two source-drain test units.

7. The apparatus for measuring the electrical property of TFT as claimed in claim 6, wherein the source-drain test units and the gate test unit are metal foils.

8. The apparatus for measuring the electrical property of TFT as claimed in claim 7, wherein the source-drain test units are connected with the source drain metals through a metal test lead, the gate test unit is connected with the gate metal through the metal test lead.

9. The apparatus for measuring the electrical property of TFT as claimed in claim 6, wherein the first voltage is a high voltage used to turn on the source and the drain, the second voltage is a predetermined value.
